(19) United States
(12) Patent Application Publication
(10) Pub. No.: US 2026/0326923 A1
(43) Pub. Date: Oct. 22, 2026

(54) SYSTEM FOR ENTERING AND EXITING AN EXTRATERRESTRIAL VEHICLE

(71) Applicant: Honeybee Robotics, LLC, Longmont, CO (US)

(72) Inventors: Kris Zacny, Altadena, CA (US); Gale Leigh Paulsen, Arcadia, CA (US); Andrew Aubert, Maple Valley, WA (US)

(21) Appl. No.: 19/186,283

(22) Filed: Apr. 22, 2025

(51) Int. Cl. B64G 1/22

(52) U.S. Cl. CPC B64G 1/222

(57) ABSTRACT

An apparatus for entering or exiting an elevated vehicle and a vehicle are disclosed. The apparatus includes a planar structure having a first surface with a plurality of cutouts extending therethrough, each cutout sized and shaped to receive the boot or glove of a pressurized suit, the planar structure having a first end configured to couple with the vehicle, the second opposing end adapted to engage a surface in an environment external to the vehicle.

### BACKGROUND OF THE DISCLOSURE

The subject matter disclosed herein relates to an apparatus for entering and exiting an elevated vehicle, and in particular to an apparatus including a structure with a plurality of cutouts and configured to couple with an elevated vehicle.

Various systems for ingress and egress have been proposed and used on extraterrestrial environments, including the Lunar environment for example. These systems typically included ladders with footpads for stabilizing the ladder. In the case of the A pollo mission lander, the Lunar Module (“LM”). the ladder consisted of a single center strut with footpads extending across. A rail was disposed on each end of the footpads.

The upper end of the strut is attached to the outboard end of a lander egress platform. The lower end of the strut had a ball joint for the footpad. The strut is of the piston-cylinder type; it absorbs the compression load of the lunar landing and supports the LM on the lunar surface.

While existing systems have proven suitable for their intended purposes the need for improvement remains, particularly in providing an apparatus and vehicle having the features described herein.

### BRIEF DESCRIPTION OF THE DISCLOSURE

According to one aspect of the disclosure an apparatus for entering and exiting an elevated vehicle is disclosed. The apparatus includes a planar structure having a first surface with a plurality of cutouts extending therethrough, each cutout sized and shaped to receive the boot or glove of a pressurized suit, the planar structure having a first end configured to couple with the vehicle, the second opposing end adapted to engage a surface in an environment external to the vehicle.

In addition to one or more of the features described herein, or as an alternative, further embodiments of the apparatus may include a plurality of hinged portions each attached to the planar structure by a hinge, each hinged portion occupying one of the plurality of cutouts when in a closed position, each hinged portion moveable from the closed position to an open position situated away the cutout. Each of the hinged portions includes a second surface, the second surface being shaped to be received in the respective cutout and being substantially co-planar with the first surface when in the closed position. The plurality of hinged portions may include one or more apertures.

In addition to one or more of the features described herein, or as an alternative, further embodiments of the apparatus is composed of an electrically charged material. The material may be aluminum.

In addition to one or more of the features described herein, or as an alternative, further embodiments of the apparatus may include at least one handrail situated near a side edge of the planar structure.

In addition to one or more of the features described herein, or as an alternative, further embodiments of the apparatus may include a winch situated adjacent to the first end of the planar structure.

In addition to one or more of the features described herein, or as an alternative, further embodiments of the apparatus may include an adjustable feature situated on the second opposing end of the planar structure.

In addition to one or more of the features described herein, or as an alternative, further embodiments of the apparatus may include a mechanism configured to stow the planar structure in the vehicle. The mechanism may be a spring mechanism.

In addition to one or more of the features described herein, or as an alternative, further embodiments of the apparatus may include cutouts that include edges that curve toward the posterior of the planar structure.

According to another aspect of the disclosure a vehicle is disclosed. The vehicle includes a body and an apparatus for entering or exiting the vehicle comprising a planar structure having a first surface with a plurality of cutouts extending therethrough, each cutout sized and shaped to receive the boot or glove of a pressurized suit, the planar structure having a first end configured to couple with the body, the second opposing end adapted to engage a surface in an environment external to the vehicle.

In addition to one or more of the features described herein, or as an alternative, further embodiments of the vehicle may include a plurality of hinged portions each attached to the planar structure by a hinge, each hinged portion occupying one of the plurality of cutouts when in a closed position, each hinged portion moveable from the closed position to an open position situated away the cutout. Each of the hinged portions includes a second surface, the second surface being shaped to be received in the respective cutout and being substantially co-planar with the first surface when in the closed position.

1 In addition to one or more of the features described herein, or as an alternative, further embodiments of the vehicle may include an apparatus composed of an electrically charged material. The material may be aluminum.

In addition to one or more of the features described herein, or as an alternative, further embodiments of the vehicle may include a winch situated adjacent to the first end of the planar structure.

In addition to one or more of the features described herein, or as an alternative, further embodiments of the vehicle may include a mechanism configured to stow the planar structure in the vehicle. The mechanism may be a spring mechanism.

In addition to one or more of the features described herein, or as an alternative, in further embodiments the vehicle is a lander.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a front view of an apparatus for entering and exiting an elevated vehicle in accordance with an embodiment;

FIG. 1B is a side view of a cutout of the apparatus of FIG. 1A in accordance with an embodiment;

FIG. 2A is a side view of the apparatus of FIG. 1A with a hinged portion in a closed position in accordance with an embodiment;

FIG. 2B is a side view of the apparatus of FIG. 1A with the hinged portion in an open position in accordance with an embodiment;

FIG. 3A is a front view of a hinged portion of the apparatus of FIG. 1A in accordance with an embodiment;

FIG. 3B is a front view of a hinged portion of the apparatus of FIG. 1A in accordance with an embodiment;

FIG. 3C is a front view of a hinged portion of the apparatus of FIG. 1A in accordance with an embodiment;

FIG. 4 is a partial perspective view of the apparatus of FIG. 1A connected to an elevated vehicle in accordance with an embodiment;

FIG. 5 is a partial perspective view of the apparatus of FIG. 1A demonstrating lifting an astronaut in accordance with an embodiment;

FIG. 6 is a partial perspective view of the apparatus of FIG. 1A demonstrating lifting a sample in accordance with an embodiment;

FIG. 7 is a front view of an apparatus for entering and exiting an elevated vehicle;

FIG. 8 is a side view of the apparatus of FIG. 7 in a stowed position and a deployed position.

The detailed description explains embodiments of the disclosure, together with advantages and features, by way of example with reference to the drawings.

### DETAILED DESCRIPTION OF THE DISCLOSURE

Embodiments of the present disclosure provide for an apparatus having cutouts to facilitate entering and exiting an elevated vehicle, for example an extraterrestrial vehicle, such as a lander. The apparatus or vehicle may be employed on the Earth or on various extraterrestrial bodies, for example the Moon, Mars, a large asteroid, or Enceladus, a moon of Saturn. Further embodiments of the present disclosure provide for an apparatus with a winch configured to lift samples or astronauts up the apparatus and into a vehicle. Still further embodiments of the present disclosure provide for hinged portions of the apparatus that occupy the cutouts.

Various systems for ingress and egress have been proposed and used on extraterrestrial environments, including the Lunar environment for example. These systems included ladders with footpads for stabilizing the ladder. These systems did not include considerations for lifting samples or injured astronauts between the lunar surface and a lander.

Embodiments described herein implement more robust structures can provide easier egress from an elevated vehicle. In these embodiments, a plurality of cutouts can enable manual ingress back into the vehicle. A winch can be incorporated to lift up a sample or astronaut that is unable to manually climb a structure for example.

The prospect of loading extraterrestrial samples from extraterrestrial bodies into extraterrestrial vehicles provides a challenge in planning for unknown conditions. It is desirable to provide a solution that offers a flexible approach so that cargo may be slid down from a vehicle in an efficient manner while also allowing for samples or injured astronauts to be lifted into the vehicle. It is also desired that the solution be suitable to operate in a vacuum, in low gravity, or in cryogenic environment.

While the Apollo missions included a ladder for entering or exiting a lunar lander. The ladder did not facilitate unloading cargo from the lander, or loading samples from the surface into the lander. Further, if an astronaut encountered an injury the ladder did not provide any alternative method of entering the lander.

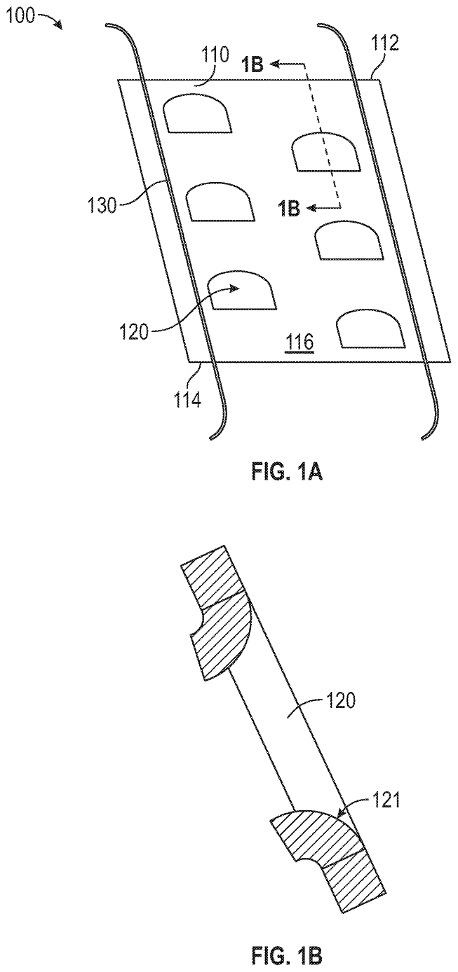

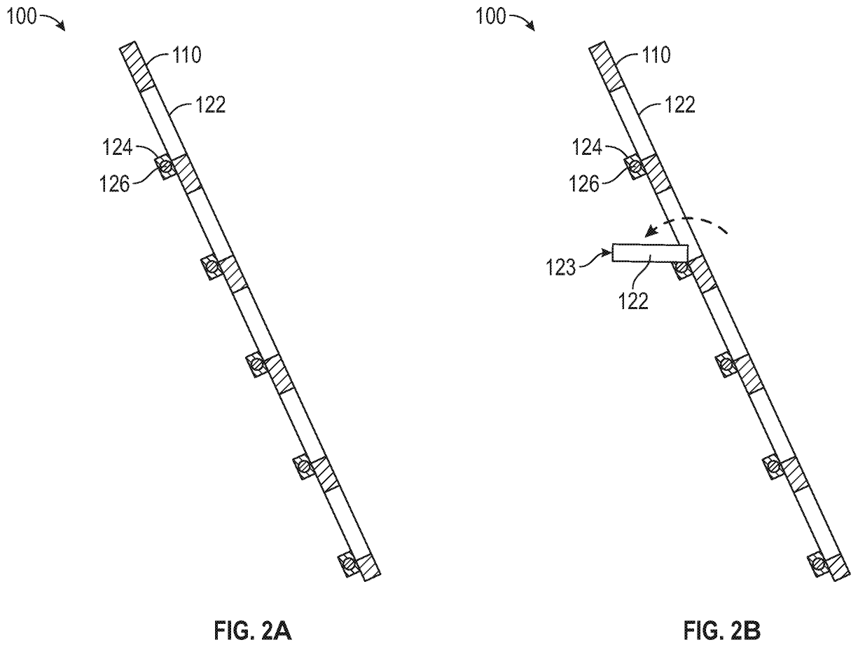

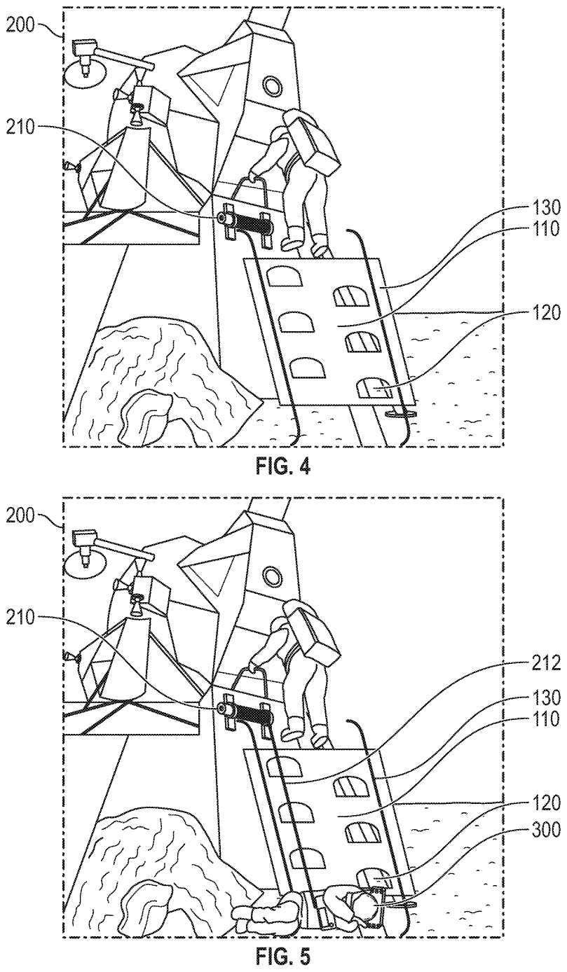

Referring now to FIGS. 1A, 1B, 2A, and 2B, an embodiment is shown of an apparatus 100 for entering or exiting an elevated vehicle, such as a lunar lander 200 (FIG. 4) for example. The apparatus 100 may include a planar structure 110 providing a framework for the apparatus 100. The planar structure 110 may be an elongated framework extending from an egress area of the elevated vehicle to the surface of the Earth or an extraterrestrial body, for example the Moon, Mars, or an asteroid. In some embodiments, the planar structure 110 may be a ramp or slide.

The planar structure 110 may include a first end 112 configured to couple with an elevated vehicle, for example a lander 200. In an embodiment, the first end 112 is configured to couple with an egress platform of the lander. The planar structure 110 may further include a second opposing end 114 adapted to engage a surface in an extraterrestrial environment. In some embodiments, the second opposing end 114 may be tapered. In some embodiments, an adjustable feature (not shown) may be coupled with the second opposing end 114 of the planar structure 110. The adjustable feature may be configurable to accommodate the position of the planar structure 110 to the surface of the extraterrestrial environment. In an embodiment, the adjustable feature may be a strut that changes in length to accommodate the distance between the second end 114 and the surface (e.g. the lunar surface).

In some embodiments, the planar structure 110 is substantially linear from the first end 112 to the second 114. In other embodiments, the structure 110 is curved from the first end 112 to the second 114. A curved structure 110 may accommodate different elevations from the ground, reducing the site selection requirements for the vehicle. Further, an astronaut or cargo may be slid down the curved structure 110 to reduce the time spent exiting the elevated vehicle. Additionally, an astronaut or cargo may be secured to the curved structure 110, the apparatus 100 may be lifted to allow the astronaut or cargo to slid into the elevated vehicle.

The planar structure 110 may include a plurality of cutouts 120 situated on a first surface of the planar structure 110 and extending through the planar structure 110. In some embodiments, each cutout 120 is of similar size and shape. Each cutout 120 may be sized and shaped to accommodate the hand or foot of a pressurized suit, for example the hand or foot of a spacesuit. In some embodiments, the pressured suit is a suit having a positive pressure differential with the environment external of the vehicle. FIG. 1A depicts six cutouts 120 but the planar structure 110 may include any number of cutouts 120 to facilitate ingress of an astronaut from an extraterrestrial surface into an elevated vehicle. For example, the planar structure 110 may include, two, three, four, five, six, seven, eight, nine, ten, eleven, twelve, thirteen, fourteen, fifteen, or sixteen cutouts 120. In some embodiments, one or more of the cutouts 120 may vary in shape. In the illustrated embodiment, the cutouts 120 have a generally flat lower edge and a curved or semi-circular upper edge. As used herein, the “lower edge” is closer to the surface than the “upper edge.” The curvature of the upper edge may be selected to provide clearance for the top surface of the astronauts boot. In an embodiment, horizontally adjacent cutouts 120 may be aligned. In another embodiment, the horizontally adjacent cutouts 120 are staggered or offset from each other.

In some embodiments, the cutouts 120 may include edges 121 that curve toward the posterior of the planar structure 110. Curved edges 121 may configured to prevent the cutouts 120 from having sharp edges to facilitate sliding of objects on the surface 116 and avoid features that could tear or puncture a spacesuit.

In an embodiment, the apparatus 100 may further include a plurality of hinged portions 122 as shown in FIG. 2A and FIG. 2B. Each hinged portion 122 may be attached to the structure 110 by a hinge 124. The hinge 124 may be located at the bottom interface of the cutout 120 with the surface 116, such that the pivot of the hinged portion 122 creates a larger surface area for the boot of a pressurized suit to bear and distribute the weight of astronauts. The hinge 124 may allow the hinged portion 122 to rotate from a closed position (depicted in FIG. 2A) to an open position (depicted in FIG. 2B). Each hinged portion 122 may occupy one of the plurality of cutouts 120 when in a closed position. In an open position, one end 123 of the hinged portion 122 may be situated away the cutout 120. For example, the hinged portion 122 may be substantially perpendicular to the cutout 120 when in an open position, or may be at a specific angle relative to the cutout 120. In some embodiments, each hinged portion 122 may be situated at a similar angle when at the open position. In other embodiments, the plurality of hinged portions 122 may be situated at varied angles when at the open position. When in an open position, the plurality of hinged portions 122 may be able to bear the weight of a person climbing the apparatus 100. For example, the plurality of hinged portions 122 may be able to bear the weight of a person in a pressurized suit after accounting for the gravity of the location.

In some embodiments, the plurality of hinged portions 122 may be simultaneously moved from a closed position to an open position, and vice versa. For example, a mechanism may connect to each hinged portion 122 or each hinge 124. Such a mechanism may be engaged to simultaneously move all hinged portions 122. For example, the mechanism may be an electromechanical actuator. In such embodiments, a rod could slide through a rail along the length of the surface 116 and interface with the electromechanical actuator. For example, the rod may run the length of the planar structure from top to bottom and interface with each cutout 120, and a mechanical actuator may interface with the rod to manipulate the hinged portions 122 filling the cutouts 120. In some embodiments, the mechanism is a rack and pinion system including an actuator or other mechanical energy source pushing a rack along the length of the planar structure 110 with pinions attached to each cutout 120. The rack and pinion system may be configured to open or close all of the cutouts 120 at once to mechanically switch between ladder and slide operations of the apparatus 100.

In other embodiments, each hinged portion 122 may be individually manually engaged by an astronaut climbing up the planar structure 110. For example, an astronaut may push a hinged portion 122 from a closed position to an open position by inserting a hand or foot into the associated cutout 120.

In some embodiments, a hinged portion 122 may stay in an open position after reaching the open position. In other embodiments, the hinged portion 122 may include a biasing member, such as a torsion spring 126 that biases the hinged portion towards the closed position after pressure is removed (e.g. when the astronaut removes their foot) from the hinged portion 122.

Each of the hinged portions 122 may include a second surface, the second surface being shaped to be received in the respective cutout 120 and being substantially co-planar with the first surface of the planar structure 110 when in the closed position. In this manner, the hinged portions 122 and planar structure 110 form a substantially uniform or uninterrupted surface. The uniform or uninterrupted surface provides advantages in reducing the risk of a payload/sample, or injured astronaut, catching on the cutouts 122 when being along the planar structure 110.

In some embodiments, the apparatus 100 may include at least one handrail 130 situated near a side edge of the planar structure 110. In further embodiments, the apparatus 100 includes two handrails 130, one handrail 130 located on each side edge of the planar structure 110. In some embodiments, the handrail 130 is curved at one or more ends. In embodiments including at least one handrail 130, an astronaut may grasp the handrail 130 and insert feet into the cutouts 120 to advance up the planar structure 110. In an embodiment, the handrail 130 may guide an object being slid along the surface 116 to avoid having the object slide off a lateral edge of the apparatus 100.

In some embodiments, the apparatus 100 may be composed of an electrically charged material. For example, the planar structure 110, the hinged portions 122, and the handrail 130 may be composed of an electrically charged material. The electrically charged material may prevent lunar dust (e.g. regolith) from accumulating on the components of the apparatus 100. In further embodiments, the electrically charged material is made from aluminum. In other embodiments, the planar structure 110 may be composed of fiberglass or carbon fiber.

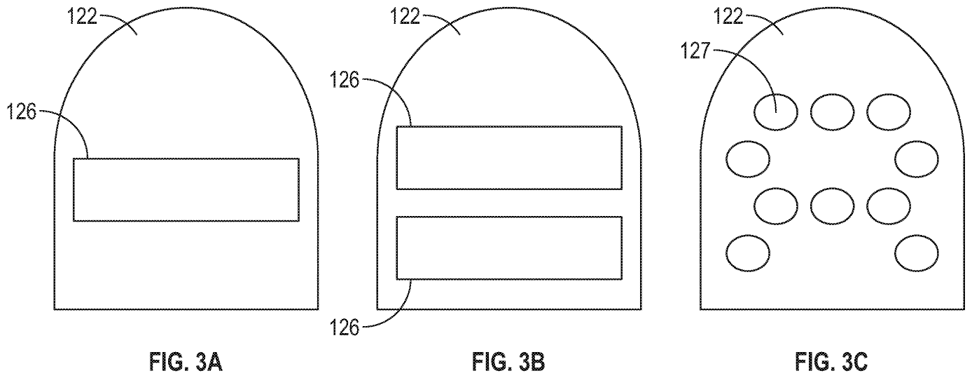

Referring now to FIGS. 3A, 3B, and 3C, the plurality of hinged portions 122 may include one or more apertures 126. FIG. 3A depicts an embodiment including one aperture 126. In such an embodiment, the aperture 126 is sufficiently large enough to accommodate at least the fingers of boot tip of an astronaut. FIG. 3B depicts an embodiment include two such apertures 126.

FIG. 3C depicts an embodiment including a plurality of apertures 127. Apertures 127 may be sized to sufficiently accommodate one finger of an astronaut. FIG. 3C depicts ten apertures 127 but the hinged portion 122 may include any number of apertures 127 necessary to facilitate ingress of an astronaut from an extraterrestrial surface into an elevated vehicle. For example, the hinged portion 122 may include, two, three, four, five, six, seven, eight, nine, ten, eleven, twelve, thirteen, fourteen, fifteen, or sixteen apertures 127.

Referring now to FIG. 4, the apparatus 100 may further include a winch 210 situated above the planar structure 110. The winch 210 may employed to lower or lift cargo or a person, for example an injured astronaut, along the planar structure 110 to facilitate egress or ingress into an elevated vehicle 200. FIG. 5 depicts an example of employing a winch 210 to lift or slide an injured astronaut 300 up a planar structure 110. The injured astronaut 300 may be attached to a winch line 212 of the winch 210. In some embodiments, the injured astronaut 300 may first be secured within a sled, basket, or other receptacle, and the receptacle may be connected to the winch line. The injured astronaut 300 may then be raised by the winch 210 along the surface 116 of planar structure 110 and up to the elevated vehicle 200. In some embodiments, the hinged portions 122 of the planar structure 110 are in a closed position while the winch 210 is in operation.

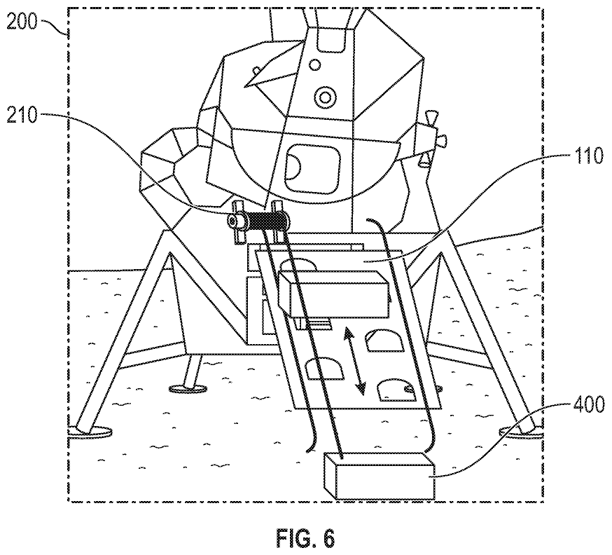

FIG. 6 depicts an example of employing a winch 210 to lower or lift an object or sample 400 along a planar structure 110. The object 400 may be attached to a winch line of the winch 210. In some embodiments, the object 400 may first be secured within a sled or other receptacle, and the receptacle may be connected to the winch line. The movement of the object 400 may then be controlled by the winch 210. In an instance where the object 400 is lowered from the elevated vehicle 200, the object 400 moves under the influence of gravity down the planar structure 110 and the winch 210 controls the rate of descent. In another instance, the object 400 is moved up the planar structure 110 and into the elevated vehicle 200. In some embodiments, the hinged portions 122 of the planar structure 110 are in a closed position while the winch 210 is in operation.

In some embodiments, the apparatus 100 includes a mechanism configured to stow the planar structure 110 in the elevated vehicle 200. For example, the mechanism may be a spring mechanism. In further embodiments, the spring mechanism may be connected to the first end of the planar structure 110 that is configured to connect to the elevated vehicle 200.

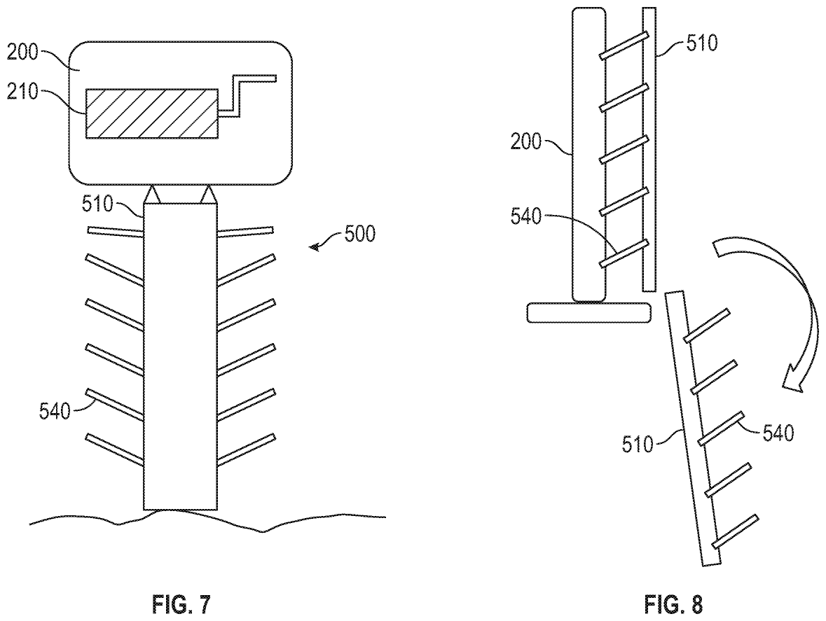

FIG. 7 depicts an alternate embodiment of apparatus 500 for entering and exiting an elevated vehicle 200. Apparatus 500 may not include cutouts in the planar structure 510. In such embodiments, a winch 210 may be used to pull cargo and/or personnel up to the vehicle 200. Apparatus may include a plurality of rungs 540 that are pitched and extending from one or more outer edges of the planar structure 510 to enable an astronaut to manually scale up or descend down the planar structure 510.

FIG. 8 is a side view of the apparatus 500 in a stowed position and a deployed position. The apparatus 500 may be stowed in a position adjacent to the vehicle 200 until needed. The apparatus 500 may then be released from the stowed position to move to the deployed position. For example, the apparatus 500 may be held in the stowed position by a latch. Disengaging the latch, for example with an activated spring, may allow the apparatus to fall to a deployed position. In some embodiments, the apparatus 500 may be deployed by a hinge with a torsion spring. When in the deployed position, the planar structure 510 may contact the ground.

Planar structure 110 or 510 may be lowered from a stowed position by a pulley system. For example, a pulley may be operably connected to one or more guide cones to guide movement of the planar structure 110/510 from the stowed position. The pulley system may employ a ratchet reel with locks to arrest movement of the planar structure 110/510.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,”“contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The descriptions of the various embodiments of the present invention have been presented for purposes of illustration, but are not intended to be exhaustive or limited to the embodiments disclosed. M any modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

1. An apparatus for entering or exiting an elevated vehicle comprising:
a planar structure having a first surface with a plurality of cutouts extending therethrough, each cutout sized and shaped to receive a boot or glove of a pressurized suit and comprising edges that curve toward a posterior of the planar structure, the planar structure having a first end configured to couple with the vehicle and a second opposing end adapted to engage a surface in an environment external to the vehicle;
at least one handrail situated near a side edge of the planar structure;
a winch situated adjacent to the first end of the planar structure;
an adjustable feature situated on the second opposing end of the planar structure;
a spring mechanism configured to stow the planar structure in the vehicle; and
a plurality of hinged portions each attached to the planar structure by a hinge, each hinged portion occupying one of the plurality of cutouts when in a closed position, each hinged portion moveable from the closed position to an open position situated away the cutout, each of the hinged portions including a second surface, the second surface being shaped to be received in the respective cutout and being substantially co-planar with the first surface when in the closed position, and each of the hinged portions comprising one or more apertures.

2. An apparatus for entering or exiting an elevated vehicle comprising:
a planar structure having a first surface with a plurality of cutouts extending therethrough, each cutout sized and shaped to receive a boot or glove of a pressurized suit, the planar structure having a first end configured to couple with the vehicle and a second opposing end adapted to engage a surface in an environment external to the vehicle; and
a plurality of hinged portions each attached to the planar structure by a hinge, each hinged portion occupying one of the plurality of cutouts when in a closed position, each hinged portion moveable from the closed position to an open position situated away the cutout.

3. (canceled)

4. The apparatus of claim 2, wherein each of the hinged portions includes a second surface, the second surface being shaped to be received in the respective cutout and being substantially co-planar with the first surface when in the closed position.

5. The apparatus of claim 2, wherein the plurality of hinged portions comprise one or more apertures.

6. The apparatus of claim 2, wherein the apparatus is composed of an electrically charged material.

7. The apparatus of claim 5, wherein the planar structure is made from aluminum.

8. The apparatus of claim 2, further comprising at least one handrail situated near a side edge of the planar structure.

9. The apparatus of claim 2, further comprising a winch situated adjacent to the first end of the planar structure.

10. The apparatus of claim 2, further comprising an adjustable feature situated on the second opposing end of the planar structure.

11. The apparatus of claim 2, further comprising a mechanism configured to stow the planar structure in the vehicle.

12. The apparatus of claim 11, wherein the mechanism is a spring mechanism.

13. The apparatus of claim 2, wherein the cutouts comprise edges that curve toward a posterior of the planar structure.

14. A vehicle comprising:
a body;
an apparatus for entering or exiting the vehicle comprising a planar structure having a first surface with a plurality of cutouts extending therethrough, each cutout sized and shaped to receive a boot or glove of a pressurized suit, the planar structure having a first end configured to couple with the body and a second opposing end adapted to engage a surface in an environment external to the vehicle; and
a plurality of hinged portions each attached to the planar structure by a hinge, each hinged portion occupying one of the plurality of cutouts when in a closed position, each hinged portion moveable from the closed position to an open position situated away the cutout.

15. (canceled)

16. The vehicle of claim 14, wherein each of the hinged portions includes a second surface, the second surface being shaped to be received in the respective cutout and being substantially co-planar with the first surface when in the closed position.

17. The vehicle of claim 14, wherein the apparatus is composed of an electrically charged material.

18. The vehicle of claim 17, wherein the material is aluminum.

19. The vehicle of claim 14, further comprising a winch situated adjacent to the first end of the planar structure.

20. The vehicle of claim 14, further comprising a mechanism configured to stow the planar structure in the vehicle.

21. The vehicle of claim 20, wherein the mechanism is a spring mechanism.

22. The vehicle of claim 14, wherein the vehicle is a lander.
